(19) United States
(12) Patent Application Publication
(10) Pub. No.: US 2024/0322875 A1
(43) Pub. Date: Sep. 26, 2024

(54) METHOD AND APPARATUS FOR TRANSMIT AND RECEIVE BEAM DETERMINATION

(71) Applicant: Huawei Technologies Co., Ltd., Shenzhen (CN)

(72) Inventors: Hamidreza Farmanbar, Kanata (CA); Mohammadhadi Baligh, Kanata (CA); Alireza Bayesteh, Brossard (CA)

(21) Appl. No.: 18/679,047

(22) Filed: May 30, 2024

Related U.S. Application Data
(63) Continuation of application No. PCT/CN2021/134817, filed on Dec. 1, 2021.

(51) Int. Cl. H04B 7/06

(52) U.S. Cl. CPC H04B 7/0617

(57) ABSTRACT

Aspects of the present disclosure enable determination of a transmit beamformer used for data transmission. The determination of the transmit beam is based on beamformed reference signals (e.g., CSI-RS, SSB) transmitted by the transmitter, such as a base station, and received by the receiver, such as a UE. The receiver feeds back information based on an angle of arrival (AoA) of the beamformed reference signal to help the transmitter determine a transmit beamformer used by the transmitter to transmitter data to the receiver. In some embodiments, the feedback information may include a projection of an angle of arrival at the receiver of a propagation path have a strongest measures reference signal on a receive beamformer. In some embodiments, the feedback information may include a beamformer to be used at the transmitter, that has been determined at the receiver.

### CROSS-REFERENCE TO RELATED APPLICATION

This application is a continuation of International Application No. PCT/CN2021/134817, filed on Dec. 1, 2021, disclosure of which is hereby incorporated by reference in its entirety.

### TECHNICAL FIELD

The present disclosure relates generally to wireless communications, and in particular embodiments, to methods and devices for transmit and received beam determination.

### BACKGROUND

In some wireless communication systems, user equipments (UEs) wirelessly communicate with a base station (BS) to send data to the base station and/or receive data from the base station. A wireless communication from a UE to a BS is referred to as an uplink (UL) communication. A wireless communication from a base station to a UE is referred to as a downlink (DL) communication.

Resources are required to perform uplink and downlink communications in such wireless communication systems. For example, a BS may wirelessly transmit data, such as a transport block (TB), using wireless signals and/or physical layer channels, to a UE in a downlink transmission at a particular frequency and over a particular duration of time. The frequency and time duration used are examples of resources.

In some wireless communication systems, beamforming is used in which a communication signal is transmitted in a particular direction instead of being transmitted omni-directionally. High frequency communication is a technology that may improve the performance of future cellular networks due to a large bandwidth for communication. However, the higher the frequency involved the smaller the antenna sizes involved. Therefore, more antennas may be needed in multiple-input multiple-output (MIMO) systems to facilitate the high frequency communication (e.g. by satisfying a certain signal to noise ratio (SNR) threshold at the receiver).

At millimeter wave (mmWave) band and THz band signal attenuation is significant and large beamforming gains are required to overcome the signal attenuation. Large beamforming gains may be achieved through using a large number of antenna elements at the BS and the UE to generate narrow beams. However, the use of narrow beams causes the transmit and receive beam alignment procedure to take longer when using beam sweeping because more beams may be needed over a given range with narrow beams than over the same range with wider beams.

Beam acquisition may become challenging due to a large searching space (i.e. a large number of possible directions where a receiver could be located) for narrow beams that may result in a longer duration of time to acquire a preferred beam to be used for communication between a transmitter and receiver and an increased time for beam failure recovery. It would be advantageous to be able to perform channel acquisition in high frequency communication systems with a reduced amount of signaling between network devices to reduce overhead and latency in the channel acquisition method.

### SUMMARY

Beams that are used for communication at higher frequencies may be narrow to focus the signal power on specific direction. Hence, a narrow beam at high frequency can be defined as a beam with a width that is sufficient to facilitate high frequency communication given the channel conditions like: path-loss, the distance and environment between the transmitter and the receiver. With narrow beams, the beam management and beam acquisition becomes more complicated. Note that at different frequency ranges, the beam widths (that facilitate the communication) are different due to different path-loss and antenna sizes, i.e., a narrow beam at low frequency is wide compared to that at high frequency.

Aspects of the present disclosure enable determination of a transmit beamformer used for data transmission. The determination of the transmit beam is based on beamformed reference signals, also known as pilots, (for example channel state information reference signal (CSI-RS) or synchronization signal block (SSB)) transmitted by the transmitter, such as a base station, and received by the receiver, such as a UE. The receiver feeds back information based on an angle of arrival of the beamformed reference signal to help the transmitter determine a transmit beamformer used by the transmitter to transmitter data to the receiver. In some embodiments, the feedback information may include a projection of an angle of arrival at the receiver of a propagation path have a strongest measures reference signal on a receive beamformer. In some embodiments, the feedback information may include a beamformer to be used at the transmitter, that has been determined at the receiver.

According to an aspect of the disclosure, there is provided a method for use by a receiver including: performing beam sweeping using a plurality of receive beams at the receiver to measure a plurality of reference signals that are beamformed at a transmitter; determining an angle of arrival (AoA) at the receiver of a propagation path having a strongest measured signal; and transmitting feedback information to the transmitter that is a function of the determined AoA of the propagation path having the strongest measured signal.

In some embodiments, the method further involves receiving data that has been beamformed at the transmitter based on the feedback information.

In some embodiments, performing beams weeping at the receiver to measure the plurality of beamformed reference signals further involves estimating a beamformed downlink channel between the transmitter and the receiver.

In some embodiments, determining the AoA of the propagation path having the strongest measured signal involves projecting the propagation path having the strongest signal on a receive beamformer used by the receiver; and transmitting the feedback information that is a function of the determined AoA of the propagation path having the strongest measured signal involves transmitting, to the transmitter, an indication of the projection of the propagation path having the strongest signal on the receive beamformer.

In some embodiments, transmitting the indication of the projection of the propagation path involves transmitting a quantized version of the indication of the projection of the propagation path.

In some embodiments, the method further involves: receiving information pertaining to the plurality of reference signals that are beamformed at the transmitter; and wherein determining the AoA is based on the information pertaining to the plurality of reference signals that are beamformed at the transmitter.

In some embodiments, beamforming used to beamform the plurality of reference signals at the transmitter is based on at least one of: channel measurements of a sensing signal corresponding to at least one receiver; a range of angle of arrival (AoD) from the transmitter values for at least one propagation path; an estimate of an AoD from the transmitter corresponding to the propagation path of the beamformed reference signal having the strongest measured signal; and estimates of AoDs from the transmitter corresponding to multiple propagation paths of beamformed reference signals having strongest measured signals.

According to an aspect of the disclosure, there is provided a device including a processor and a computer-readable medium. The computer-readable medium has stored thereon, computer executable instructions, that when executed cause the processor to: perform beam sweeping using a plurality of receive beams at the receiver to measure a plurality of reference signals that are beamformed at a transmitter; determine an AoA at the receiver of a propagation path having a strongest measured signal; and transmit feedback information to the transmitter that is a function of the determined AoA of the propagation path having the strongest measured signal.

According to an aspect of the disclosure, there is provided a method for use by a receiver comprising: performing beam sweeping using a plurality of receive beams at the receiver to measure a plurality of reference signals that are beamformed at a transmitter; determining an AoA at the receiver of a propagation path having a strongest measured signal; determining an AoD at the transmitter for a propagation path to provide a strongest communication signal; and transmitting feedback information to the transmitter that is a function of the determined AoD.

In some embodiments, the method further involves receiving data that has been beamformed at the transmitter based on the feedback information.

In some embodiments, performing beam sweeping at the receiver to measure the plurality of beamformed reference signals further comprises estimating a beamformed downlink channel between the transmitter and the receiver.

In some embodiments, determining the AoA of the propagation path having the strongest measured signal further comprises projecting the propagation path having the strongest signal on a receive beamformer used by the receiver.

In some embodiments, the determining the AoD of the propagation path to be beamformed at the transmitter and the determining the AoA of the propagation path having the strongest measured signal are performed jointly.

In some embodiments, transmitting the feedback information to the transmitter that is a function of the determined AoD comprises transmitting at least one of: an explicit indication of the determined AoD; an index value identifying a transmit beam corresponding to the determined AoD; or an indication of a transmit beam that corresponds to the AoD.

In some embodiments, the method further involves: receiving information pertaining to the plurality of reference signals that are beamformed at the transmitter.

In some embodiments, beamforming used to beamform the plurality of reference signals at the transmitter is based on at least one of: channel measurements of a sensing signal corresponding to at least one receiver; a range of AoD values for at least one propagation path; an estimate of an AoD corresponding to the propagation path of the beamformed reference signal having the strongest measured signal; and estimates of AoDs corresponding to multiple propagation paths of beamformed reference signals having strongest measured signals.

According to an aspect of the disclosure, there is provided a device including a processor and a computer-readable medium. The computer-readable medium has stored thereon, computer executable instructions, that when executed cause the processor to: perform beam sweeping using a plurality of receive beams at the receiver to measure a plurality of reference signals that are beamformed at a transmitter; determining an AoA at the receiver of a propagation path having a strongest measured signal; determining an AoD at the transmitter for a propagation path to provide a strongest communication signal; and transmitting feedback information to the transmitter that is a function of the determined AoD.

According to an aspect of the disclosure, there is provided a method for use by a transmitter including: transmitting a plurality of beamformed reference signals; receiving feedback information from a receiver, the feedback information being a function of an AoA at the receiver of a propagation path having a strongest measured signal, the AoA being determined at the receiver based on measurement of the plurality of beamformed reference signals; and determining beamforming to be used at the transmitter, based on the feedback information, for transmitting data to the receiver.

In some embodiments, the method further involves transmitting the data using the determined beamforming.

In some embodiments, receiving the feedback information involves receiving an indication of a projection of the propagation path having the strongest measured signal at the receiver on a receive beamformer; and determining the beamforming for use at the transmitter based on the indication of the projection of the propagation path having the strongest measured signal.

In some embodiments, receiving the indication of the projection of the propagation path involves receiving: the projection of the propagation path having the strongest measured signal at the receiver on a receive beamformer; or a quantized version of the projection of the propagation path having the strongest measured signal at the receiver on a receive beamformer.

In some embodiments, the method further involves: transmitting information pertaining to the plurality of reference signals that are beamformed at the transmitter; and wherein the feedback information is based on the information pertaining to the plurality of reference signals that are beamformed at a transmitter.

In some embodiments, beamforming used to beamform the plurality of reference signals at the transmitter is based on at least one of: channel measurements of a sensing signal corresponding to at least one receiver; a range of AoD values for at least one propagation path; an estimate of an AoD corresponding to the propagation path of the beamformed reference signal having the strongest measured signal; and estimates of AoDs corresponding to multiple propagation paths of beamformed reference signals having strongest measured signals.

According to an aspect of the disclosure, there is provided a device including a processor and a computer-readable medium. The computer-readable medium has stored thereon, computer executable instructions, that when executed cause the processor to: transmit a plurality of beamformed reference signals; receive feedback information from a receiver, the feedback information being a function of an AoA of a propagation path of the channel having a strongest measured signal, the AoA being determined at the receiver based on measurement of the plurality of beamformed reference signals; and determine beamforming to be used at the transmitter, based on the feedback information, for transmitting data to the receiver.

According to an aspect of the disclosure, there is provided a method for use by a transmitter involving: transmitting a plurality of beamformed reference signals; receiving feedback information from a receiver, the feedback information being a function of an AoD of a propagation path to provide a strongest signal for the receiver, the AoD being determined at the receiver based on measurement of the plurality of beamformed reference signals; and determining beamforming to be used at the transmitter, based on the feedback information, for transmitting data to the receiver.

In some embodiments, the method further involves: transmitting the data using the determined beamforming.

In some embodiments, receiving the feedback information from a receiver involves receiving at least one of: an explicit indication of the determined AoD; an index value identifying a transmit beam corresponding to the determined AoD; or an indication of a transmit beam that corresponds to the AoD.

In some embodiments, the method further involves: transmitting information pertaining to the plurality of reference signals that are beamformed at the transmitter; and wherein the feedback information is based on the information pertaining to the plurality of reference signals that are beamformed at the transmitter.

In some embodiments, beamforming used to beamform the plurality of reference signals at the transmitter is based on at least one of: channel measurements of a sensing signal corresponding to at least one receiver; a range of AoD values for at least one propagation path; an estimate of an AoD corresponding to the propagation path of the beamformed reference signal having the strongest measured signal; and estimates of AoDs corresponding to multiple propagation paths of beamformed reference signals having strongest measured signals.

According to an aspect of the disclosure, there is provided a device including a processor and a computer-readable medium. The computer-readable medium has stored thereon, computer executable instructions, that when executed cause the processor to: transmit a plurality of beamformed reference signals; receive feedback information from a receiver, the feedback information being a function of an AoD of a propagation path to provide a strongest signal for the receiver, the AoD being determined at the receiver based on measurement of the plurality of beamformed reference signals; and determine beamforming to be used at the transmitter, based on the feedback information, for transmitting data to the receiver.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the disclosure may occur.

FIG. 1B is another schematic diagram of a communication system in which embodiments of the disclosure may occur.

FIG. 2 is a block diagram illustrating example electronic devices and network devices.

FIG. 3 is a block diagram illustrating units or modules in a device in which embodiments of the disclosure may occur.

FIG. 4 is an example of an environment including a transmitter, a receiver and multiple buildings that act to block and reflect transmit beams from the receiver.

FIG. 5A is an example of a signaling flow diagram according to aspects of the present disclosure.

FIG. 5B is another example of a signaling flow diagram according to aspects of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Beam acquisition for massive MIMO systems can be challenging at high frequencies such as millimeter wave (mmWave) and subTHz band (>100 GHz) due to the large overhead of control signaling and processing time needed when performing beam sweeping (due to beam sweeping overhead) via narrow beams. An increase in latency can also be another issue impacting beam acquisition at mmWave and subTHz frequencies.

When performing beam sweeping via narrow beams, the transmitter sends reference signals via the narrow beams in different directions while the receiver searches via narrow beams for reference signals transmitted by the transmitter, also in a number of different directions. Examples of a type of reference signal that may be transmitted by a transmitter, such as a base station, may be a channel state information reference signal (CSI-RS) or a positioning reference signal (PRS). An example of a type of reference signal that may be transmitted by a receiver, such as a user equipment (UE), may be a sounding reference signal (SRS). If only narrow beams are being used, then many beams may be needed, as opposed to when wide beams are used, fewer beams may be needed. Beam sweeping overhead involves a number of beam pairs (a transmitter beam and a receiver beam forming a beam pair) that are searched in order to find one or more beam pairs that have preferred characteristics (e.g., best signal strength) for data communication between the transmitter and receiver. Besides the number of beam pairs, the beam sweeping overhead also depends on a duration to perform the measurement (e.g. measurement of the receive signal strength). The time to perform the measurement may also depend on the sequence length. The variation in sequence length determines quality of the measurement. For example, a longer sequence length results in high quality and shorter length results in lower quality. However, a longer sequence length results in higher overhead. Therefore, there is a tradeoff between measurement quality and the amount of overhead. Note that with fixed duration per measurement of one beam-pair, the beam sweeping overhead is reduced when searching among fewer beam-pairs to find one or more beam pairs that have preferred characteristics (e.g., best signal strength).

Sensing technology may be used to perceive the environment in the area of a transmitter, which enables a transmission channel on at least one beam pair to be determined between the transmitter and receiver. In some implementations, if the propagation environment is known a priori, an mmWave channel can be estimated with higher accuracy and less overhead, especially in massive antenna arrays and for large bandwidth.

As compared to sub-6 GHZ communication systems, the propagation environment for mmWave and sub-THz consists of objects that act as reflectors as opposed to objects that may scatterer a communication signal. Therefore, in the propagation environment for mmWave and sub-THz much of the signal energy is restricted to line-of-sight (LOS) paths and reflected paths.

Sensing of the environment may be used to assist beamforming, for example beam acquisition, as well as beam management. Sensing may enable minimizing, and possibly eliminating beam sweeping as part of the beam acquisition process. Sensing may enable minimizing channel state information (CSI) acquisition overhead and minimizing latency in the acquisition process. Sensing may also enable the transmitter, or the network the transmitter communicates with, to follow the receiver using channel predication. For example, in some embodiments, as part of a sensing functionality the transmitter may be able to determine movement (speed and direction) of the receiver and based on such determined movement may be able to predict future movement of the receiver. Based on the determined movement and/or prediction of the movement, the transmitter may be able to estimate the channel for the determined movement and/or the predicted movement. Sensing may also enable proactive beam management. Beam management may involve aligning a transmit (Tx) beam from the transmitter side and a receive (Rx) beam from the receiver side to form a transmit receive beam pair. Beam management may also consist of at least one of beam training and beam tracking.

Aspects of the present disclosure enable determination of a transmit beamformer used for data transmission. The determination of the transmit beam is based on beamformed reference signals, also known as pilots, (CSI-RS or SSB) transmitted by the transmitter, such as a base station, and received by the receiver, such as a UE. The receiver feeds back information based on an angle of arrival of the beamformed reference signal to help the transmitter determine a transmit beamformer used by the transmitter to transmitter data to the receiver. In some embodiments, the feedback information may include a projection of an angle of arrival at the receiver of a propagation path have a strongest measures reference signal on a receive beamformer. In some embodiments, the feedback information may include a beamformer to be used at the transmitter, that has been determined at the receiver.

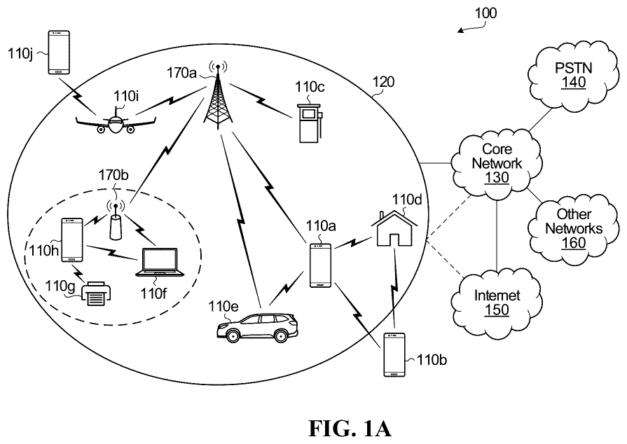

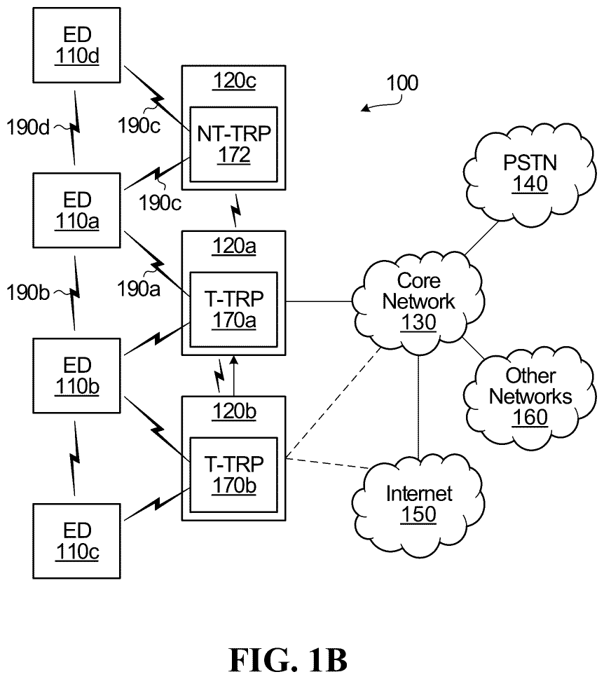

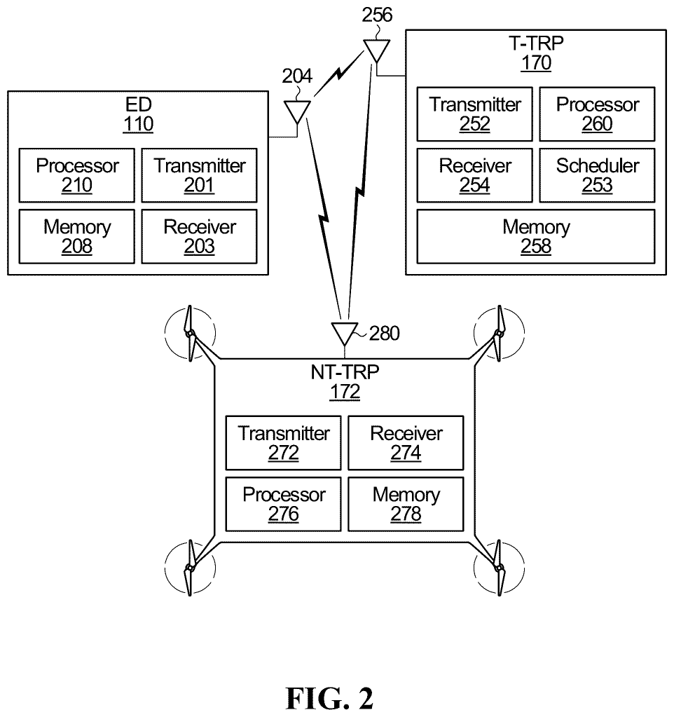

FIGS. 1A, 1B, and 2 provide context for the network and devices of a wireless communication system that may implement aspects of the mobility management methods of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example wireless communication system 100 (hereinafter referred to as system 100) which includes a network in which embodiments of the inter-cell mobility management methods of present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

The communication system 100 may provide a wide range of communication services and applications (such as earth monitoring, remote sensing, passive sensing and positioning, navigation and tracking, autonomous delivery, and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such technologies.

The EDs 110a-110c communicate with one another over one or more SL air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the T-TRPs 170a-170b or NT-TRPs 172, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

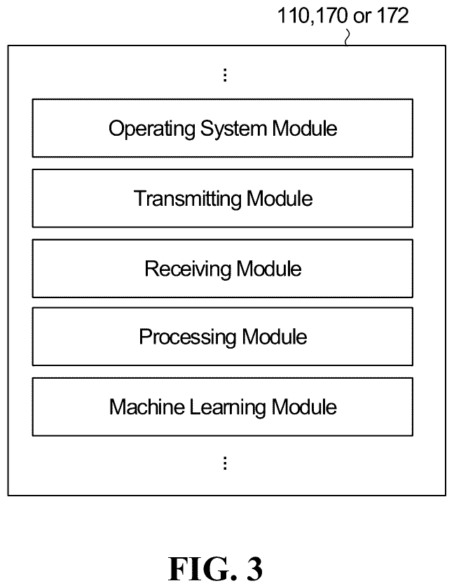

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprises several framework, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

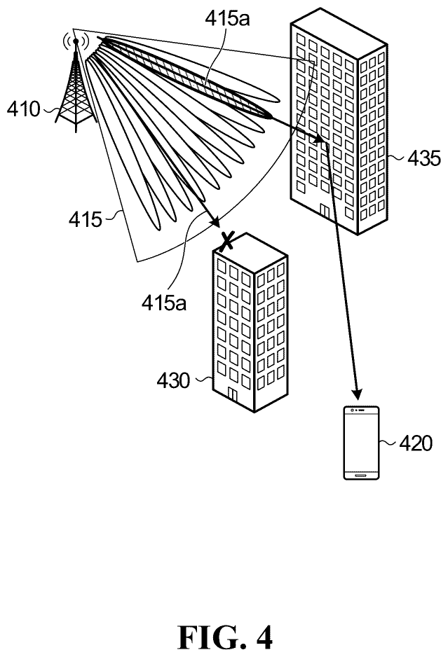

FIG. 4 illustrates a diagram of how an object in a line of sight (LoS) path between a base station 410 and a UE 420 disrupts a direct path of communication and so an alternative propagation path and corresponding transmit/receive beam pair may be determined. The base station 410 may transmit in multiple directions using multiple transmit beams 415. A first transmit beam 415a is shown to be in a substantially straight line between the base station 410 and the UE 420. However, a first building 430 blocks the first transmit beam 415a. A second transmit beam 415b reflects off of a second building 435 in the direction of UE 420. Being able to determine a transmit receive beam pair in a manner that could reduce the amount of beam sweeping that would otherwise be needed for many narrow beams would be advantageous in reducing the amount of signaling overhead and possibly improve latency.

In some current implementations of beam management and channel state indication channel acquisition, a base station transmits beamformed reference signals, the UE measures the received beamformed signal and provides feedback to the base station in the form of the signal strength measurements and the base station can determine a transmit beamformer to be used to transmit data to the UE based on the strongest beam pair. However, in such a strongest beam pair method, the transmit beamformer at the base station and the receive beamformer at the UE are limited to beam pairs used during beam sweeping, which may not be aligned with the strongest propagation path. When the transmit beam and the receive beam are not aligned with a strongest propagation path this means the directions of the beams may not provide a robust channel. Furthermore, use of wide beams in beam sweeping for determining a transmit beamformer for reference signal beamforming may provide coarse granularity and may result in low accuracy of beam determination, whereas use of narrow beams in beam sweeping results in large beam sweeping overhead.

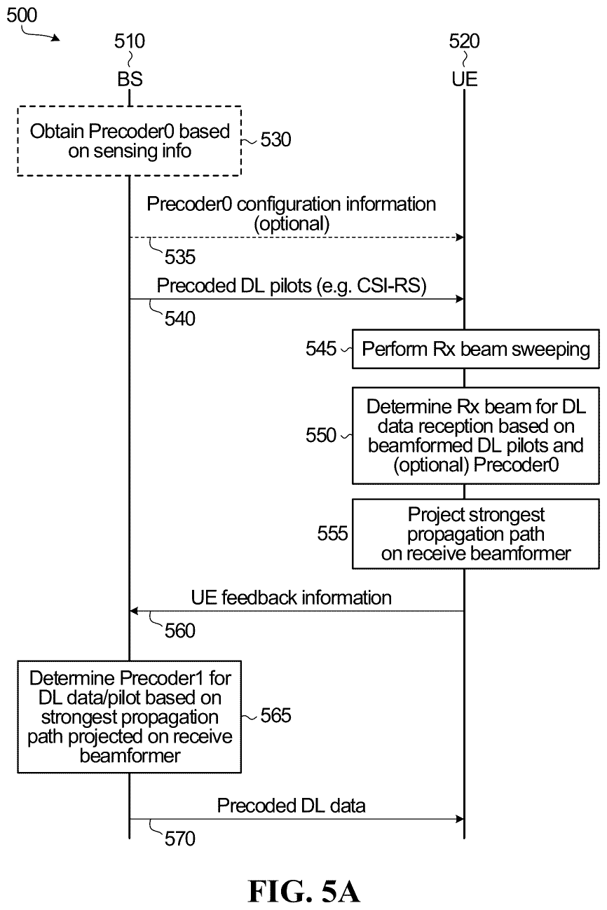

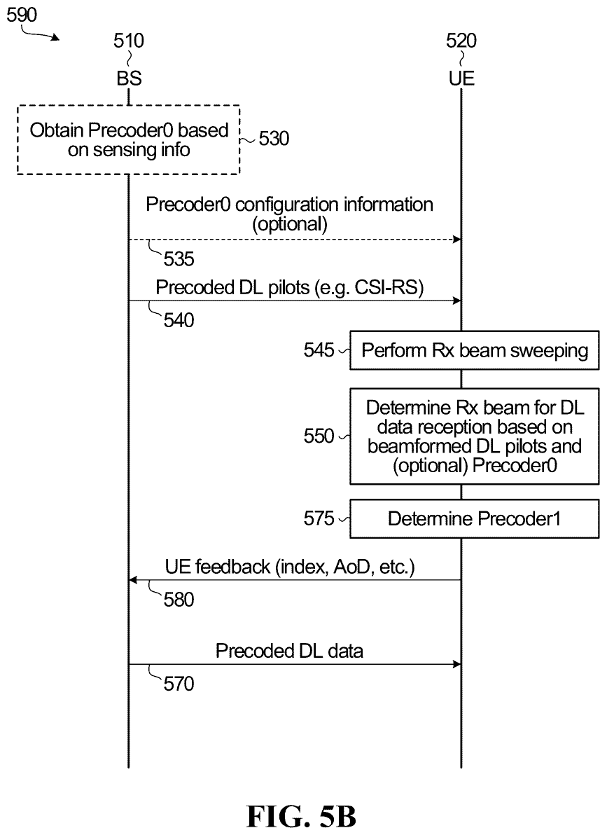

FIG. 5A illustrates a signaling flow diagram 500 between a transmitter and a receiver for use in beam management according to an aspect of the present disclosure. In the example of FIG. 5A, the transmitter is a base station (BS) 510 and the receiver is a user equipment (UE) 520. At a first step 530, which is optional, the BS 510 obtains information pertaining to beamforming that may be used to beamform reference signals that will be transmitted by the BS 510. The beamforming information used to beamform the reference signals at the BS 510 may be referred to as transmit side “Precoder0”. Obtaining the transmit side Precoder0 may be considered optional as the BS 5120 may already have the transmit side Precoder0 information. The beamformed reference signals may also be referred to as beamformed pilots. The beamformed reference signals are eventually measured by the UE 520 and the UE 520 feeds back information about the measured reference signals to determine beamforming that will be used by the BS 510 in creating a robust propagation path between the BS 510 and the UE 520 on a transmit receive beam pair.

The information that is obtained at step 530 may be obtained by performing radio frequency (RF) environment sensing. The RF environment sensing may include the BS 510 transmitting a sensing reference signal in multiple directions and receiving a reflected version of the sensing reference signals. For example, the sensing reference signal may reflect off of the UE 520 and off of other objects in the geographical area.

In some embodiments, the beamforming used to beamform the plurality of reference signals at the BS 510 is based on a range of angle of arrival (AoD) values for at least one propagation path. In some embodiments, the beamforming used to beamform the plurality of reference signals at the BS 510 is based on an estimate of an AoD corresponding to a strongest propagation path of the channel. The strongest path is the path with largest amplitude. In some embodiments, the beamforming used to beamform the plurality of reference signals at the BS 510 is based on estimates of AoDs corresponding to multiple propagation paths of the channel.

In some embodiments, the transmit side Precoder0 may be DFT beams to cover an AoD range of interest. In some embodiments, the transmit side Precoder0 may be composed of random beams projected on DFT beams within the AoD range. In some embodiments, the transmit side Precoder0 may be subspace beams, for example from principal component analysis (PCA) or a linear autoencoder. In PCA or autoencoder approach, the significant vectors for representing channel sample vectors are identified and can be used as precoder. Some examples of this may be described in Applicant's co-pending application PCT/CN2020/130431, filed on Nov. 20, 2020 (attorney docket No. 87013057PCT01)

The UE 520 may also have beamformer information to configure receive beams used to receive, which may be referred to as receive side “Precoder0”. The receive side Precoder0 may be used to perform beam sweeping to receive signals before the UE 520 is either provided with, or the UE 520 determines, a particular receive beam with a strongest propagation path between the BS 510 and the UE 520. The receive side Precoder0 information may be installed in the UE 520 as a default setting, and/or may be provided to the UE as part of the IA process, or provided through RRC or MAC-CE.

In an optional signaling 535, the BS 510 may send configuration information to the UE 520 that informs the UE 520 of the transmit side Precoder0. Transmit side Precoder0 may be sent to the UE through RRC signaling or MAC-CE. This information may help the UE 520 to determine AoD(s) of the beamformed beam(s) at the BS and/or angle of arrival(s) (AoA)(s) of the beamformed beam(s) at the UE of the most significant path(s) of the downlink channel with higher accuracy.

Signaling 540 sent by the BS 510 involves the BS 510 transmitting the reference signals that have been beamformed using transmit beam sweeping according to the transmit side Precoder0. The beamformed reference signals may be referred to as Precoded DL pilots, such as CSI-RS, as shown in the example of FIG. 5A.

At step 545, the UE 520 performs receive (Rx) beam sweeping that involves measuring the reference signals that have been beamformed at the base station 510 using transmit side Precoder0 by application of receive side Precoder0. The receive beam sweeping uses the receive side Precoder0. Performing receive beam sweeping involves measuring the beamformed reference signals to determine values of one or more of: reference signal received power (RSRP); signal-to-noise ratio (SNR); received signal strength indicator (RSSI); or Reference Signal Received Quality (RSRQ). Furthermore, performing receive beam sweeping may involve measuring real and complex values of the beamformed reference signals, which may be considered to be a coherent measurement.

In embodiments of the present disclosure the BS 510 and the UE 520 may each include an antenna array. For example, the BS 510 has an array of T antenna elements and the UE has an array of R antenna elements. The multiple input multiple output (MIMO) channel between the BS 510 and the UE 520 can be denoted as H_{R×T}. A number of transmit beams used in beam sweeping by the BS 510 to transmit the reference signals as beamformed reference signals, for example as performed in signaling 540, is M transmit beams. A number of receive beams used in beam sweeping by the UE 520 to receive the beamformed reference signals, for example as performed in step 545, is N receive beams.

The UE 520 may also estimate a beamformed channel between the transmit beams at the BS 510 and the received beams at the UE 520. A downlink channel may be represented in a matrix formulation as

$${H}_{R \times T} = \sum {α}_{i} {a}_{r} ( {θ}_{r}^{i} ) {a}_{t}^{*} ( {θ}_{t}^{i} )$$

where aᵣ(θᵣⁱ) is the receive antenna array steering vector corresponding to AoA θᵣⁱ for path i, where i is an integer number of possible paths, aₜ*(θₜⁱ) is a conjugate transpose of aₜ(θₜⁱ), which is the transmit antenna array steering vector corresponding to AoD θₜⁱ for path i, and αᵢ is the complex channel gain corresponding to path i.

A beamformed channel seen by the UE 520 may be represented in a matrix formulation as

$${\tilde{H}}_{R \times M} = {HW}_{t} + Z$$

where H is the downlink channel matrix H_{R×T} of size R×T, M is the number of transmit beams, Wₜ is a matrix representation of a transmit beamformer (transmit side Precoder0) used for beam sweeping by the BS 510 having a matrix size T×M, where Tis the number of antenna elements in the BS antenna array and Z is matrix of noise values having a matrix size R×M.

The transmit-receive beamformed channel as considered at the receiver may be represented in a matrix formulation as

$${N \times M}_{} = {W}_{r}^{*} {HW}_{t} + {W}_{r}^{*} Z$$

where N is the number of receive beams, Wᵣ* is a matrix representation of a conjugate transpose of Wᵣ, which is a receive beamformer (receive side Precoder0) to be used for beam sweeping at the UE 520 for receiving the beamformed sensing reference signals having a matrix size N×R.

Using the measurements determined at step 545, the UE 520 then determines 550 an AoA of a propagation path between the base station 510 and the UE 520 that has a strongest measured signal and a corresponding receive (Rx) beam for DL data reception. The UE 520 may determine the strongest measured signal based on the largest value of RSRP, SNR, RSSI or RSRQ. When the transmit side Precoder0 information is provided to the UE 520 in optional signaling 535, the transmit side Precoder0 information may also be used in determining the AoA of the propagation path that has a strongest measured signal in step 550.

The UE determines the AoA (\hat{θ}r) corresponding to strongest path given the measurement [symbol] _{N×M}.

In some embodiments, estimation of AoA given [symbol] may include correlation-based angle estimation.

Using the measurements determined at step 550, the UE 520 then projects the propagation path having the strongest measured signal on a receive beamformer used by the receiver.

When considering a matrix implementation of the propagation path having the strongest measured signal on a receive beamformer, after the AoA \hat{θ}ᵣ is determined, the UE 520 projects columns of the channel matrix [symbol] onto the direction of receive side beamformer used for data reception. The result of the projection may be a vector that can be provided to the BS 510 to find a transmit beamformer for data transmission. One example of how this may be represented is as follows

$$g = \frac{{a}_{r}^{*} ( {\hat{θ}}_{r} ) {W}_{r}}{‖ {a}_{r}^{*} ( {\hat{θ}}_{r} ) {W}_{r} ‖}$$

where g is the projection result and aᵣ(\hat{θ}r) is the receive side beamformer for data reception.

Another example of how this may be represented is as follows

$${g}_{ac} = \frac{\vert {a}_{r}^{*} ( {\hat{θ}}_{r} ) {W}_{r} \vert}{‖ {a}_{r}^{*} ( {\hat{θ}}_{r} ) {W}_{r} ‖} \vert \vert$$

where g_{nc} is a non-coherent version the projection result.

The UE 520 then transmits 560 a signal to the BS 510 that includes UE feedback pertaining to the projection result of the propagation path on the receive beamformer. In some embodiments, the UE 520 sends the projection result, i.e. g or g_{nc}, to the BS 510 through a designated feedback channel. In some embodiments, the UE 520 sends a discretized (or quantized) value of the projection result to the BS 510 through a designated feedback channel.

Based on the UE feedback that the BS 510 receives in the UE feedback signaling 560, the BS 510 can determine 565 a transmit beamformer that may be used to send data to the UE 520. The transmit beamformer used at the BS 510 may be referred to as a transmit side Precoder1 as shown in FIG. 5A.

There may be many methods for the BS to determine Precoder1. An example of such a method involves the BS 510 obtaining an estimate of an angle of departure (AoD) (\hat{θ}ₜ) of a strongest propagation path using the following relationship:

$${\hat{θ}}_{t} = arg {max}_{{θ}_{t} ∈ AoD range} \frac{{\vert {gW}_{t}^{*} {a}_{t} ( {θ}_{t} ) \vert}^{2}}{{\vert {W}_{t}^{*} {a}_{t} ( {θ}_{t} ) ‖}^{2}}$$

Another example of such a method, which is complementary to determining a non-coherent projection result g_{nc} described above involves using the following relationship:

$${\hat{θ}}_{t} = arg {max}_{{θ}_{t} ∈ AoD range} \frac{{\vert {g}_{nc} \vert {W}_{t}^{*} {a}_{t} ( {θ}_{t} ) \vert \vert}^{2}}{{‖ {W}_{t}^{*} {a}_{t} ( {θ}_{t} ) ‖}^{2}}$$

The BS 510 may then obtain the transmit side Precoder1 in the form

w=aₜ(\hat{θ}ₜ)

Based on the transmit beamformer determined at step 565, the BS 510 transmits 570 precoded DL data to the UE 520 using the determined transmit beamformer.

There may be many methods for the BS to determine Precoder1. An example of such a method in which the AoA determined in step 550 and the AoD determined in step 575 are determined jointly involves the BS 510 obtaining an estimate of an AoD (\hat{θ}ₜ) and AoA (\hat{θ}ᵣ) of a beamformed signal corresponding to a strongest propagation path using the following relationship:

$$( {\hat{θ}}_{r} , {\hat{θ}}_{t} ) = arg {max}_{( {θ}_{r} , {θ}_{t} ) ∈ AoD / AoA range} \frac{{\vert {a}_{r}^{*} ( {θ}_{r} ) {W}_{r} {W}_{t}^{*} {a}_{t} ( {θ}_{t} ) \vert}^{2}}{{‖ {W}_{r}^{*} {a}_{r} ( {θ}_{r} ) ‖}^{2} {‖ {W}_{t}^{*} {a}_{t} ( {θ}_{t} ) ‖}^{2}}$$

An advantage of embodiments in which the UE determines and AoA and provides feedback to the BS based on the determined AoA may be that such a method provides an improved SNR loss as compared to simply determining a strongest transmit-receive beam pair by the UE measuring signal strengths on receive beams and feeding back the measured signal strength values to the base station. In other words, given a same number of transmit-receive beam sweeps, embodiments of the method described herein have a smaller loss as compared to other methods that may currently be used. A reason for improved performance is that given the transmit-receive beamformed channel measurement [symbol] , such embodiments, find a receive beam beamformer for use at the UE 520 and Precoder1 for use at the BS 510 corresponding to estimates of AoD and AoA of a strongest path of the channel that are more accurate than estimates corresponding to the strongest beam pair method.

FIG. 5B illustrates a signaling flow diagram 590 between a BS 510 and a UE 510 for use in beam management according to another embodiment of the present disclosure. Several of the steps are the same as described in FIG. 5A and use the same numbering of reference characters to note the similarity. At a first step 530, which is optional, the BS 510 obtains information pertaining to beamforming that may be used to beamform reference signals that will be transmitted by the BS 510. As described above with regard to FIG. 5A, the information that is obtained may be obtained by performing RF environment sensing.

In optional signaling 535, the BS 510 may send configuration information to the UE 520 that informs the UE 520 of Precoder0. Signaling 540 involves the BS 510 transmitting reference signals that have been beamformed according to Precoder0 on multiple transmit beams.

At step 545, the UE 520 performs receive beam sweeping that involves measuring the reference signals that have been beamformed at the base station 510 using Precoder0. The receive beam sweeping uses the receive side Precoder0. Performing receive beam sweeping involves measuring the beamformed reference signal to determine values of one or more of RSRP, SNR, RSSI or RSRQ.

Using the measurements determined at step 545, the UE 520 then determines 550 an AoA of a propagation path between the base station 510 and the UE 520 that has a strongest measured signal. The UE 520 may determine the strongest measured signal based on the largest value of RSRP, SNR, RSSI or RSRQ. When the transmit side Precoder0 information is provided to the UE 520 in optional signaling 535, the transmit side Precoder0 information may also be used in determining the AoA of the propagation path that has a strongest measured signal in step 550.

Using the measurements determined at step 550, the UE 520 then determines at step 575 a transmit beamformer that may be used by the BS 510 to send data to the UE 520. The transmit beamformer may be referred to as Precoder1 as shown in FIG. 5B. In some embodiments, determining a transmit beamformer may involve determining an AoD of a propagation path to be beamformed at the transmitter based at least in part on the determined AoA.

In some embodiments, the AoA determined in step 550 and the AoD determined in step 575 may be determined sequentially, as shown in FIG. 5B. In some embodiments, the AoA determined in step 550 and the AoD determined in step 575 may be determined jointly.

An example of such a method in which the AoA determined in step 550 and the AoD determined in step 575 are determined jointly involves the BS 510 obtaining an estimate of an AoD (\hat{θ}ₜ) and AoA (\hat{θ}ᵣ) of a beamformed signal corresponding to a strongest propagation path using the following relationship:

$$( {\hat{θ}}_{r} , {\hat{θ}}_{t} ) = arg {max}_{( {θ}_{r} , {θ}_{t} ) ∈ AoD / AoA range} \frac{{\vert {a}_{r}^{*} ( {θ}_{r} ) {W}_{r} {W}_{t}^{*} {a}_{t} ( {θ}_{t} ) \vert}^{2}}{{‖ {W}_{r}^{*} {a}_{r} ( {θ}_{r} ) ‖}^{2} {‖ {W}_{t}^{*} {a}_{t} ( {θ}_{t} ) ‖}^{2}}$$

The UE 520 may then transmit 580 UE feedback corresponding to the transmit beamformer determined at step 575 to the BS 510.

In some embodiments, the UE 520 may determine an estimated AoD that is needed at the BS 510. The UE sends 580 the UE feedback that includes the estimated AoD. The BS 510 then determines Precoder1 based on the AoD estimate by the UE. One example of determining the Precoder 1 is to generate a transmit antenna array steering vector corresponding to the estimated AoD.

In some embodiments, the UE feedback corresponding to the transmit beamformer that is sent to the BS 510 by the UE 520 is an explicit indication of the determined AoD. In some embodiments, the UE 520 sends the determined AoD to the BS 510 through a designated feedback channel. In some embodiments, the UE 520 sends a discretized (or quantized) value of the determined AoD to the BS 510 through a designated feedback channel.

In some embodiments, the UE feedback corresponding to the transmit beamformer that is sent to the BS 510 by the UE 520 is an index value identifying a transmit beam corresponding to the determined AoD. In some embodiments, the UE feedback corresponding to the transmit beamformer that is sent to the BS 510 by the UE 520 is an indication of a transmit beam that corresponds to the AoD.

The BS 510 can then use the UE feedback corresponding to the transmit beamformer received in signaling 580 to transmit 570 precoded DL data to the UE 520 using the transmit beamformer information.

Advantages of embodiments corresponding to FIG. 5B may be similar to that described above for FIG. 5A.

A further benefit of embodiments corresponding to FIG. 5B with respect to embodiments corresponding to FIG. 5A is that the UE in the method shown in FIG. 5B can determine transmit Precoder1 with higher accuracy as compared to the UE shown in the method corresponding to FIG. 5A when a quantized value of the projection is transmitted by the UE to be used at the BS to determine Precoder 1.

Embodiments described herein consider beam acquisition between a BS and target UE for downlink communication. However, it should be understood that the described method according to an embodiment (for example as described with regard to FIGS. 5A and 5B) could be applied to uplink and/or side-link communication as well.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
performing beam sweeping using a plurality of receive beams at a receiver to measure a plurality of reference signals that are beamformed at a transmitter;
determining an angle of arrival (AoA) at the receiver of a propagation path having a strongest measured signal; and
transmitting feedback information to the transmitter, the feedback information being a function of the AoA.

2. The method of claim 1, further comprising:
receiving data that has been beamformed at the transmitter based on the feedback information.

3. The method of claim 1, wherein the performing the beam sweeping at the receiver to measure the plurality of reference signals further comprises:
estimating a beamformed downlink channel between the transmitter and the receiver.

4. The method of claim 1, wherein:
the determining the AoA comprises:
projecting the propagation path on a receive beamformer used by the receiver; and
the transmitting the feedback information comprises:
transmitting an indication of projection of the propagation path having the strongest measured signal on the receive beamformer.

5. The method of claim 4, wherein the transmitting the indication of the projection of the propagation path comprises:
transmitting a quantized version of the indication of the projection of the propagation path.

6. A device at a side of a receiver, comprising:
at least one processor;
a computer-readable medium having stored thereon, computer executable instructions, that when executed by the at least one processor, cause the device to perform operations including:
performing beam sweeping using a plurality of receive beams at the receiver to measure a plurality of reference signals that are beamformed at a transmitter;
determining an angle of arrival (AoA) at the receiver of a propagation path having a strongest measured signal; and
transmitting feedback information to the transmitter, feedback information being a function of the AoA.

7. The device of claim 6, the operations further comprising:
receiving data that has been beamformed at the transmitter based on the feedback information.

8. The device of claim 6, wherein the performing the beam sweeping at the receiver to measure the plurality of reference signals comprises:
estimating a beamformed downlink channel between the transmitter and the receiver.

9. The device of claim 6, wherein:
the determining the AoA comprises:
projecting the propagation path on a receive beamformer used by the receiver; and
the transmitting the feedback information comprises:
transmitting an indication of projection of the propagation path having the strongest measured signal on the receive beamformer.

10. The device of claim 9, wherein the transmitting the indication of the projection of the propagation path comprises:
transmitting a quantized version of the indication of the projection of the propagation path.

11. A method comprising:
transmitting a plurality of beamformed reference signals;
receiving feedback information from a receiver, the feedback information being a function of an angle of arrival (AoA) at the receiver of a propagation path having a strongest measured signal, the AoA being determined at the receiver based on measurement of the plurality of beamformed reference signals; and
determining beamforming to be used at a transmitter, based on the feedback information, for transmitting data to the receiver.

12. The method of claim 11 further comprising:
transmitting the data to the receiver using the beamforming.

13. The method of claim 11, wherein:
the receiving the feedback information comprises:
receiving an indication of a projection of the propagation path having the strongest measured signal at the receiver on a receive beamformer; and
determining the beamforming for use at the transmitter based on the indication of the projection of the propagation path having the strongest measured signal.

14. The method of claim 13, wherein the receiving the indication of the projection of the propagation path comprises receiving:
the projection of the propagation path having the strongest measured signal at the receiver on the receive beamformer; or
a quantized version of the projection of the propagation path having the strongest measure signal at the receiver on the receive beamformer.

15. The method of claim 11, further comprising:
transmitting information pertaining to the plurality of beamformed reference signals that are beamformed at the transmitter,
wherein the feedback information is based on the information pertaining to the plurality of beamformed reference signals that are beamformed at the transmitter.

16. A device at a side of a transmitter comprising:
at least one processor;
a computer-readable medium having stored thereon, computer executable instructions, that when executed by the at least one processor, cause the device to perform operations including:
transmitting a plurality of beamformed reference signals;
receiving feedback information from a receiver, the feedback information being a function of an angle of arrival (AoA) at the receiver of a propagation path having a strongest measured signal, the AoA being determined at the receiver based on measurement of the plurality of beamformed reference signals; and
determining beamforming to be used at the transmitter, based on the feedback information, for transmitting data to the receiver.

17. The device of claim 16, to the operations further comprising:
transmitting the data to the receiver using the beamforming.

18. The device of claim 16, wherein:
the receiving the feedback information comprises:
receiving an indication of a projection of the propagation path having the strongest measured signal at the receiver on a receive beamformer; and
determining the beamforming for use at the transmitter based on the indication of the projection of the propagation path having the strongest measured signal.

19. The device of claim 18, wherein the receiving the indication of the projection of the propagation path comprises receiving:
the projection of the propagation path having the strongest measured signal at the receiver on the receive beamformer; or
a quantized version of the projection of the propagation path having the strongest measure signal at the receiver on the receive beamformer.

20. The device of claim 16, the operations further comprising:
transmitting information pertaining to the plurality of beamformed reference signals that are beamformed at the transmitter,
wherein the feedback information is based on the information pertaining to the plurality of beamformed reference signals that are beamformed at the transmitter.
